(19) United States
(12) Patent Application Publication
(10) Pub. No.: US 2026/0332050 A1
(43) Pub. Date: Oct. 22, 2026

(54) DMOS FIELD PLATE BIASING AND DRIVERS

(71) Applicant: Renesas Electronics America Inc., Milpitas, CA (US)

(72) Inventors: Anurag KAPLISH, Milpitas, CA (US); Meng Chia LEE, Milpitas, CA (US); Kijeong HAN, Milpitas, CA (US); Gourab SABUI, Milpitas, CA (US); Marco ZUNIGA, Milpitas, CA (US)

(73) Assignee: Renesas Electronics America Inc., Milpitas, CA (US)

(21) Appl. No.: 19/419,825

(22) Filed: Dec. 15, 2025

Related U.S. Application Data
(60) Provisional application No. 63/790,930, filed on Apr. 18, 2025.

(51) Int. Cl. H02M 3/158; H02M 3/00

(52) U.S. Cl. CPC H02M 3/158; H02M 3/003

(57) ABSTRACT

A switching regulator includes a high-side switch and a low-side switch coupled in series between an input voltage and a ground potential via a common terminal. An inductor is coupled to the common terminal, and an output capacitor is configured to generate an output voltage based on a current flowing through the inductor. The high-side switch is a first MISFET with a field plate structure including a first gate electrode and a first field plate electrode. The first gate electrode and the first field plate electrode are configured to be controlled independently of each other. The low-side switch is a second MISFET with a field plate structure including a second gate electrode and a second field plate electrode. The second gate electrode and the second field plate electrode are configured to be controlled independently of each other.

### CROSS-REFERENCE TO RELATED APPLICATION

This application claims the benefit under 35 U.S.C. §119(e) to U.S. Provisional Application No. 63/790,930, filed on Apr. 18, 2025, titled “RESURF AND MULTI-GATE TECHNIQUES FOR LDMOS DEVICES,” the entire disclosure of which is incorporated by reference herein.

### BACKGROUND

The present disclosure generally relates to the field of semiconductor device fabrication, and more particularly to drain-extended metal-oxide-semiconductor (DMOS) transistors and associated field-plate biasing structures.

DMOS transistors combine high voltage tolerance, high current capability, fast switching characteristics, and robust performance, making them a superior choice for many power electronics applications. Bipolar-CMOS-DMOS (BCD) technology has become the mainstream process for power management integrated circuits (PMICs), with the DMOS transistor serving as the primary power processing device.

Power devices represent some of the largest contributors to die size and overall cost in PMICs. The specific on-resistance, Rsp (typically expressed in units of mΩ·mm²), is one of the principal figures of merit for DMOS power devices utilized in the linear region of operation. Rsp reflects the die-area utilization efficiency of the device for a given on-state resistance RDSON.

Compact power devices with low Rsp are highly desirable, and significant design effort is directed toward minimizing this parameter. However, reducing Rsp often introduces competing trade-offs. For instance, lowering the on-resistance typically requires increasing the channel width or reducing the drift-region resistance, both of which can undesirably increase parasitic capacitance, degrade breakdown voltage, or complicate field-plate optimization. Similarly, aggressive scaling of the drift region or field-oxide thickness to reduce resistance can result in high electric-field crowding, adversely affecting device reliability and long-term performance.

### SUMMARY

According to an embodiment of the present disclosure, a switching regulator includes a high-side switch and a low-side switch coupled in series between an input voltage and a ground potential via a common terminal. The switching regulator further includes an inductor coupled to the common terminal, and an output capacitor configured to generate an output voltage based on a current flowing through the inductor. The high-side switch is a first MISFET with a first field plate structure including a first gate electrode and a first field plate electrode, the first gate electrode and the first field plate electrode are configured to be controlled independently of each other. The low-side switch is a second MISFET with a second field plate structure including a second gate electrode and a second field plate electrode, the second gate electrode and the second field plate electrode are configured to be controlled independently of each other.

According to an embodiment of the present disclosure, a switching regulator includes an inductor and a high-side switch coupled in series between an input voltage and an output voltage via a common terminal. The switching regulator further includes a low-side switch coupled between the common terminal and a ground potential, and an output capacitor configured to generate the output voltage based on a current flowing through the inductor. The high-side switch is a first MISFET with a first field plate structure including a first gate electrode and a first field plate electrode, the first gate electrode and the first field plate electrode are configured to be controlled independently of each other. The low-side switch is a second MISFET with a second field plate structure including a second gate electrode and a second field plate electrode, the second gate electrode and the second field plate electrode are configured to be controlled independently of each other.

### BRIEF DESCRIPTION OF THE DRAWINGS

The following detailed description, given by way of example and not intended to limit the embodiments described herein, will best be appreciated in conjunction with the accompanying drawings, in which:

FIG. 1A illustrates a switching regulator configured as a buck converter, according to an embodiment of the present disclosure;

FIG. 1B schematically illustrates a symbol representation of a metal-insulator-semiconductor field-effect transistor (MISFET) having a single field-plate structure, according to an embodiment of the present disclosure;

FIG. 1C illustrates a cross-sectional view of a semiconductor device that may be used as either high-side or low-side switch in FIG. 1A, according to embodiments of the present disclosure;

FIG. 1D schematically shows a symbol representation of a MISFET including at least two field-plate electrodes, according to an embodiment of the present disclosure;

FIG. 1E illustrates a cross-sectional view of a semiconductor device including a plurality of field plates, according to embodiments of the present disclosure.

FIG. 1F illustrates a switching regulator in which only the high-side switch includes a field-plate structure, according to an embodiment of the present disclosure;

FIG. 1G illustrates a switching regulator in which only the low-side switch incorporates a field-plate structure, according to an embodiment of the present disclosure;

FIG. 1H illustrates a block diagram of a switching regulator including a controller, high-side gate drivers, low-side gate drivers, and a bootstrap circuit, according to an embodiment of the present disclosure;

FIG. 2A illustrates a switching regulator configured as a boost converter, according to an embodiment of the present disclosure;

FIG. 2B illustrates a switching regulator in which only the high-side switch includes a field-plate structure, according to an embodiment of the present disclosure;

FIG. 2C illustrates a switching regulator in which only the low-side switch includes a field-plate structure, according to an embodiment of the present disclosure;

FIG. 2D illustrates a block diagram of a switching regulator including a controller, high-side gate drivers, low-side gate drivers, and bootstrap circuit, according to an embodiment of the present disclosure;

FIG. 3A schematically illustrates a symbolic representation of a MISFET device having a single field-plate electrode associated with a low-side switch configuration, according to an embodiment of the present disclosure;

FIG. 3B schematically illustrates a symbolic representation of a MISFET device having multiple field-plate electrodes associated with a low-side switch configuration, according to an embodiment of the present disclosure;

FIG. 4 illustrates a switching regulator configured as a buck converter, according to an embodiment of the present disclosure;

FIG. 5 illustrates a switching regulator, configured as a boost converter, having a modified arrangement of the high-side and low-side field-plate electrodes and their respective bias connections, according to an embodiment of the present disclosure;

FIG. 6 shows example switching waveforms for a buck converter low-side device including a single field-plate electrode, according to an embodiment of the present disclosure;

FIG. 7 illustrates example timing waveforms for a variation including two independently driven low-side field-plate electrodes, according to an embodiment of the present disclosure;

FIGS. 8A and 8B illustrate example configurations of low-side field-plate (LSFP) bias and driver circuits, according to various embodiments of the present disclosure; and

FIGS. 9A and 9B illustrate example configurations of high-side field-plate (HSFP) bias and driver circuits, according to various embodiments of the present disclosure.

The drawings are not necessarily to scale. The drawings are merely schematic representations, not intended to portray specific parameters of the embodiments in the present disclosure. The drawings are intended to depict typical embodiments of the present disclosure. In the drawings, like numbering represents like elements.

### DETAILED DESCRIPTION

Detailed embodiments of the claimed structures and methods are disclosed herein; however, it can be understood that the disclosed embodiments are merely illustrative of the claimed structures and methods that may be embodied in various forms. The claimed structures and methods may, however, be embodied in many different forms and should not be construed as limited to the exemplary embodiments set forth herein. In the description, details of various conventional features and techniques may be omitted to avoid unnecessarily obscuring the presented embodiments.

For purposes of the description hereinafter, terms such as “upper”, “lower”, “right”, “left”, “vertical”, “horizontal”, “top”, “bottom”, and derivatives thereof shall relate to the disclosed structures and methods, as oriented in the drawing figures. Terms such as “above”, “overlying”, “atop”, “on top”, “positioned on” or “positioned atop” mean that a first element, such as a first structure, is present on a second element, such as a second structure, wherein intervening elements, such as an interface structure may be present between the first element and the second element. The term “direct contact” means that a first element, such as a first structure, and a second element, such as a second structure, are connected without any intermediary conducting, insulating or semiconductor layers at the interface of the two elements.

In the interest of not obscuring the presentation of embodiments of the present disclosure, in the following detailed description, some processing steps or operations that may be ordinary in the art may have been combined together for presentation and for illustration purposes and in some instances may have not been described in detail. In other instances, some processing steps or operations that may be ordinary in the art may not be described at all. It should be understood that the following description is rather focused on the distinctive features or elements of various embodiments of the present disclosure.

Compact DMOS power devices are designed to minimize the specific on-resistance Rsp to achieve high current capability and efficient die utilization. In a standard DMOS device, the half-pitch, defined as the distance between the middle of the body region and the middle of the drain region, plays a critical role in determining Rsp. A smaller pitch generally results in lower Rsp. However, aggressive pitch scaling adversely impacts the breakdown voltage (BVDSS) and hot-carrier injection (HCI) performance due to increased electric-field crowding and non-uniform potential distribution in the drift region. Thus, a fundamental trade-off exists between minimizing Rsp and BVDSS/HCI performance.

To address this trade-off, embodiments of the present disclosure provide circuit configurations utilizing DMOS devices incorporating one or more independently biased field plates. In a first variant, a buck regulator that receives input voltage (Vᵢₙ₁) and generates a lower output voltage (Vₒᵤₜ₁) is implemented using a DMOS device having single or multiple field plates. The field plates are configured to optimize the electric-field distribution across the drift region, thereby maximizing breakdown voltage and HCI performance while enabling a reduced device pitch and lower Rsp. In another variant, a boost regulator that receives an input voltage (Vᵢₙ₂) and generates a higher output voltage (Vₒᵤₜ₂) is implemented using the DMOS device with single or multiple field plates. The biasing or driving techniques described herein can be extended to such buck and boost regulator configurations, where each field plate may be biased to a distinct potential to achieve finer control over the electric-field gradient and to further balance the trade-off among Rsp, BVDSS, and reliability. These approaches may enable practical integration of the DMOS device into scalable and flexible power management architectures suitable for use in advanced BCD and power management processes.

Embodiments of the present disclosure further provide driver circuits and biasing methods for controlling the gate electrode and the field plate or plates of the DMOS device, including static and dynamic bias schemes that maintain desired electric-field profiles and switching characteristics under varying operating conditions in power converter circuits.

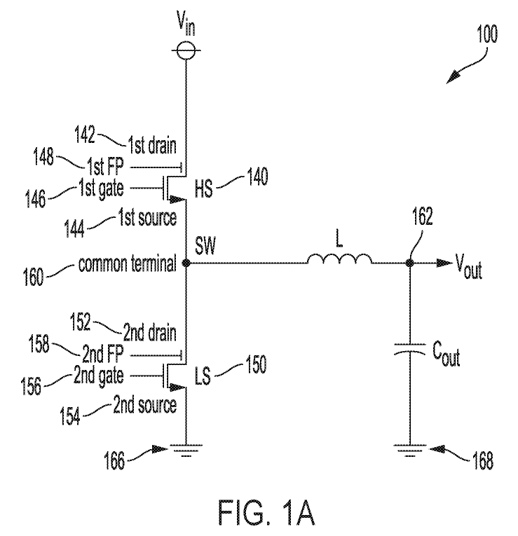

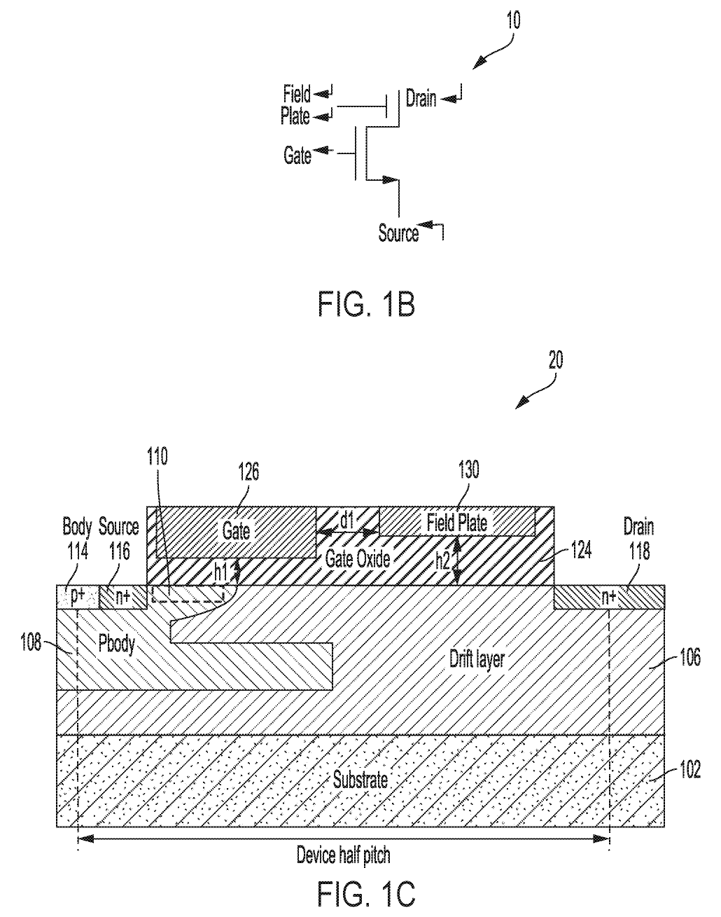

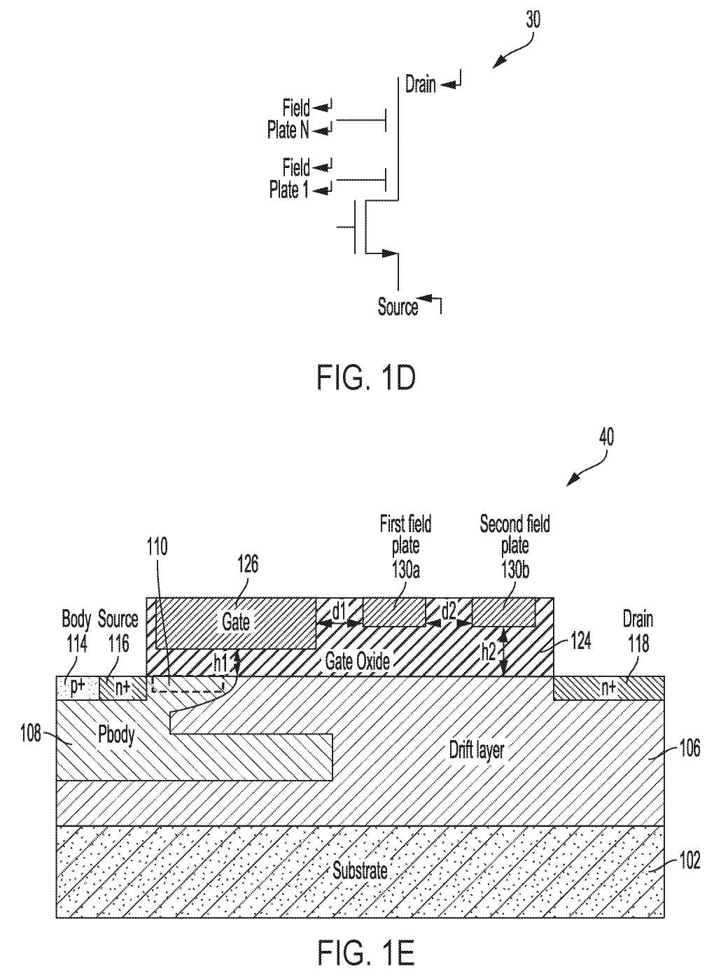

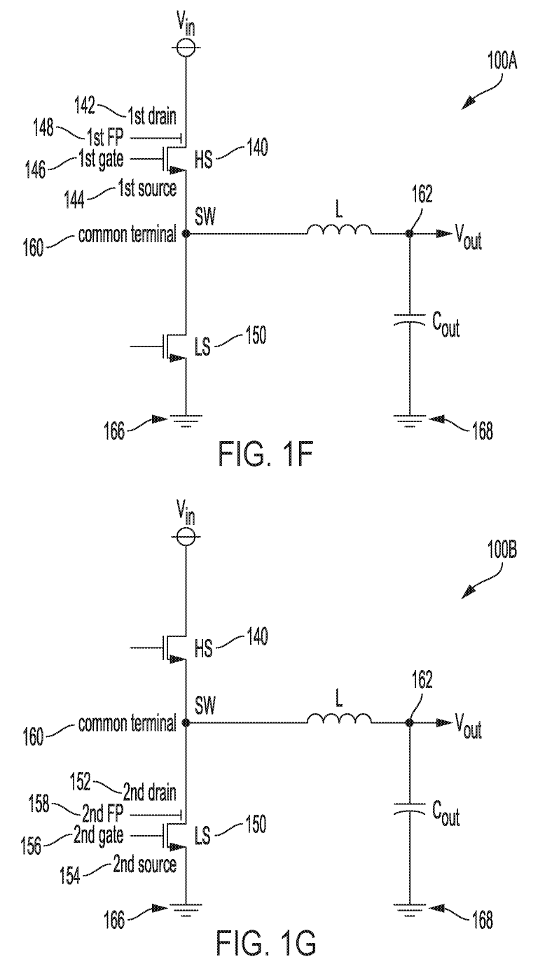

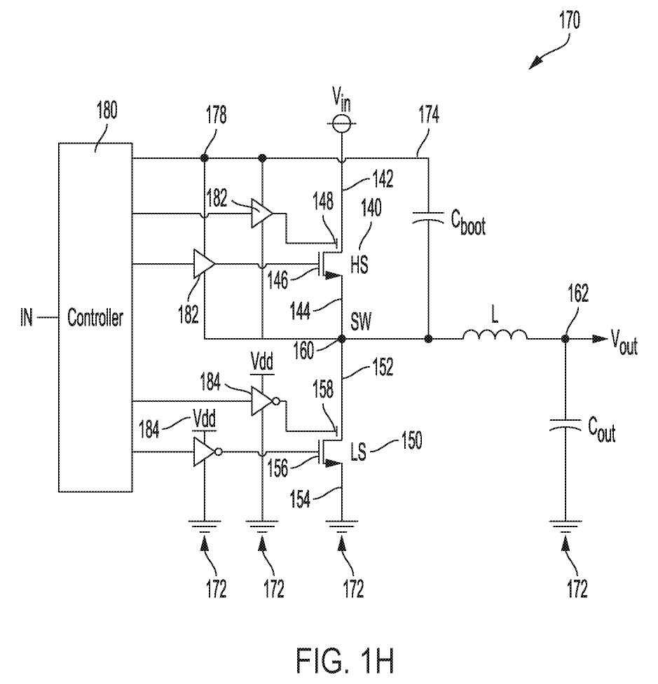

Embodiments by which DMOS-based switching regulator circuits with single-field-plate and multi-field-plate DMOS devices can be implemented are described in detail below with reference to the accompanying drawings in FIGS. 1A-9B.

FIG. 1A illustrates a switching regulator 100 configured as a buck converter, according to an embodiment of the present disclosure.

The switching regulator 100 (buck converter) is configured to step down an input voltage (Vᵢₙ) to generate an output voltage (Vₒᵤₜ). The switching regulator 100 includes a high-side (HS) switch 140 and a low-side (LS) switch 150 coupled in series between the input voltage Vᵢₙ and a ground potential 166 through a common terminal 160 (switching node SW). In the context of the present disclosure, the common terminal 160 corresponds to the switching node SW, at which the high-side switch 140 and the low-side switch 150 are coupled in series. An inductor L is coupled to the common terminal 160, and an output capacitor Cₒᵤₜ is connected between an output node 162 and a ground potential 168 to smooth the output voltage Vₒᵤₜ derived from a current flowing through the inductor L.

As shown in FIG. 1A, both the high-side switch 140 and the low-side switch 150 are implemented as metal-insulator-semiconductor field-effect transistors (MISFETs) that include field-plate (FP) structures. The high-side switch 140 includes a first drain 142, a first source 144, a first gate electrode 146, and a first field-plate electrode 148. Similarly, the low-side switch 150 includes a second drain 152, a second source 154, a second gate electrode 156, and a second field-plate electrode 158.

The first gate electrode 146 and the first field-plate electrode 148 are spaced apart from each other and are configured to be independently controlled by their corresponding gate drivers. Likewise, the second gate electrode 156 and the second field-plate electrode 158 are spaced apart and independently controlled.

In the illustrated configuration, both MISFETs are preferably implemented as laterally diffused MOSFETs (LDMOSFETs) fabricated on a silicon or silicon-on-insulator (SOI) substrate. Each of the first and second field-plate electrodes 148, 158 may be biased to a voltage higher than that of its corresponding gate electrode to optimize the electric-field distribution in a drift region of the device, thereby enhancing breakdown voltage (BVDSS) and hot-carrier-injection (HCI) performance while maintaining a low specific on-resistance (Rsp). It should be noted that, in the context of the present disclosure, a MISFET is a metal-insulator-semiconductor field-effect transistor that may be realized using metal-oxide-semiconductor field-effect transistor (MOSFET) technology, including laterally diffused MOSFETs (LDMOSFETs), where a field-plate electrode is incorporated to improve high-voltage performance by modulating the lateral electric field within the drift region.

FIG. 1B schematically illustrates a symbol representation 10 of a MISFET having a single field-plate structure, while FIG. 1C illustrates a cross-sectional view of a corresponding semiconductor device 20 that may be used as either the high-side or low-side switch in FIG. 1A, according to embodiments of the present disclosure.

The semiconductor device 20 may be formed on a semiconductor substrate (hereinafter “substrate”) 102, which may be a silicon or SOI substrate. The substrate 102 may have a thickness suitable for mechanical support and for isolating high-voltage regions from the bulk.

A drift layer 106 of a first conductivity type is disposed over the substrate 102. For example, when the semiconductor device 20 is an n-channel DMOS transistor, the first conductivity type of the drift layer 106 is n-type. The drift layer 106 may be epitaxially grown to a desired thickness and doping concentration that establishes a predetermined breakdown voltage (BVDSS). The drift layer 106 laterally extends between a body region (or body) 114 on one side and a drain region (or drain) 118 on the opposite side, defining a device half-pitch as shown in FIG. 1C.

A p-body region (also referred to as p-body) 108 of a second conductivity type (e.g., p-type) opposite to that of the drift layer 106 is formed in an upper portion of the drift layer 106, typically by ion implantation followed by thermal activation. The p-body region 108 serves to form a p-n junction with the drift layer 106 to support high-voltage operation. Within the p-body region 108, a source region (or source) 116 of the first conductivity type is formed, for example by shallow implantation and annealing. The source region 116 provides a low-resistance contact for carrier injection during device conduction. A heavily doped p+ contact region may optionally be provided within the body region 114 to ensure reliable body contact and to suppress parasitic bipolar effects.

Overlying the drift layer 106 and the p-body region 108 is a first insulating film, referred to as a gate oxide 124. The gate oxide 124 may be a thermally grown silicon dioxide (SiO₂) or a stacked oxide/nitride/oxide (ONO) structure having a first thickness h1 varying from approximately 1 nm to approximately 100 nm. A gate electrode 126 is disposed above the gate oxide 124 and positioned over a channel region 110 formed in the p-body region 108. The gate electrode 126 may be composed of polysilicon, metal gate material (such as TiN, W, or Al), or a combination thereof, and may be patterned using conventional lithography and etching techniques.

Adjacent to the gate electrode 126 is a field plate 130, which is disposed above the drift layer 106 and spaced apart from the gate electrode 126 by a distance d1. The distance d1 may be in the range of approximately 5 nm to approximately 50 µm. The field plate 130 is electrically isolated from the drift layer 106 by a second insulating film, which may be the same material as or different from the gate oxide 124. In the embodiment of FIG. 1C, the second insulating film corresponds to an extension of the gate oxide 124 having a second thickness h2 greater than the thickness h1 of the first insulating film. The second thickness h2 of the second insulating film (thick portion of the gate oxide 124) may vary between approximately 1 nm to approximately 5 mm or less. The field plate 130 may be formed of the same conductive material as the gate electrode 126 and patterned in a separate or simultaneous masking step.

The drain region 118 of the first conductivity type is positioned within the drift layer 106 at an end of the field plate 130 opposite to the gate electrode 126. The drain region 118 may be formed by ion implantation followed by annealing to achieve a low contact resistance. The gate electrode 126 and the field plate 130 may be simultaneously activated or independently activated depending on the desired device performance. The field plate 130 may be biased to a fixed potential, dynamically driven, or connected through a resistive or capacitive coupling network to tailor the electric-field distribution across the drift layer 106.

The gate electrode 126 and the field plate 130 allow the electric field in the drift layer 106 to be redistributed, thereby reducing field peaks and improving BVDSS and HCI performance without significantly increasing Rsp.

FIG. 1D schematically shows a symbol representation 30 of a MISFET including at least two field-plate electrodes, while FIG. 1E illustrates a cross-sectional view of a semiconductor device 40 incorporating a plurality of field plates 130a, 130b disposed over the drift layer 106, according to embodiments of the present disclosure.

In FIG. 1E, the same reference numerals are used to identify components identical or similar to those in FIG. 1C, and detailed descriptions of such components are omitted to avoid unnecessary repetition.

In this embodiment, a first field plate 130a and a second field plate 130b are disposed over the drift layer 106 and separated by a distance d2. The distance d2 between the first field plate 130a and the second field plate 130b may vary between approximately 1 nm to approximately 10 mm, and ranges therebetween. Each field plate may be independently biased or driven to a distinct potential to establish a multi-step electric-field gradient across the drift layer 106.

The use of multiple field plates 130 provides finer control of the electric-field distribution, resulting in further improvement of breakdown voltage, on-resistance trade-off, and hot-carrier reliability. It should be noted that although only two field plates 130 (e.g., field plates 130a, 130b) are depicted in FIG. 1E, any number of field plates 130 may be provided depending on the desired device design, voltage rating, and performance requirements. The plurality of field plates 130 may be simultaneously activated, independently biased, or sequentially driven in an order beginning with the field plate 130 closest to the gate electrode 126 (e.g., field plate 130a) and ending with the field plate closest to the drain region 118 (e.g., field plate 130b). Such activation sequencing provides additional flexibility in managing the dynamic electric-field profile during high-speed switching events.

FIG. 1F illustrates a switching regulator 100A in which only the high-side switch 140 includes a field-plate structure, according to an embodiment of the present disclosure. In this embodiment, the low-side switch 150 is implemented as a standard MOSFET without a field plate. This configuration may be beneficial when the high-side transistor experiences higher voltage stress and benefits from enhanced breakdown voltage, while reducing cost and area for the low-side device.

FIG. 1G illustrates a switching regulator 100B in which only the low-side switch 150 incorporates a field-plate structure, according to an embodiment of the present disclosure. In this embodiment, the high-side switch 140 is implemented as a standard MOSFET. This configuration may be useful in synchronous buck converters where the low-side transistor conducts for longer intervals, providing improved Rsp and HCI performance for higher efficiency.

FIG. 1H illustrates a block diagram of a switching regulator 170 including a controller 180, high-side gate drivers 182, low-side gate drivers 184, and a bootstrap circuit 174, according to an embodiment of the present disclosure. The controller 180 receives an input control signal (IN) and produces complementary control signals for the high-side switch 140 and low-side switch 150.

The high-side gate drivers 182 drive the first gate electrode 146 and the first field-plate electrode 148 independently, while the low-side gate drivers 184 drive the second gate electrode 156 and the second field-plate electrode 158 independently. Each of the low-side gate drivers 184 is supplied with a driver supply voltage (Vdd) that provides the necessary drive potential for controlling the low-side switch 150 and its associated field-plate electrode 158. The controller 180 is configured to operate the high-side gate drivers 182 and low-side gate drivers 184 such that the high-side and low-side groups (each comprising a gate electrode and its corresponding field plate) are driven in a complementary manner to prevent cross-conduction.

The bootstrap circuit 174 includes a bootstrap capacitor (C_{boot}) coupled between a supply node 178 of the high-side drivers 182 and the common terminal 160. During operation, the bootstrap circuit 174 generates a boosted voltage above the switching-node potential (SW), providing adequate gate-drive voltage for the high-side switch 140 (e.g., N-channel high-side MISFET). This boosted voltage may enable full enhancement of the high-side transistor (i.e., high-side switch 140) while preserving duty-cycle control and minimizing conduction loss.

The controller 180, high-side gate drivers 182 and low-side gate drivers 184 may be implemented as discrete circuits or integrated within the same die or package as the power transistors. The field-plate biasing and drive concepts described herein may also be extended to other converter topologies such as boost or half-bridge regulators.

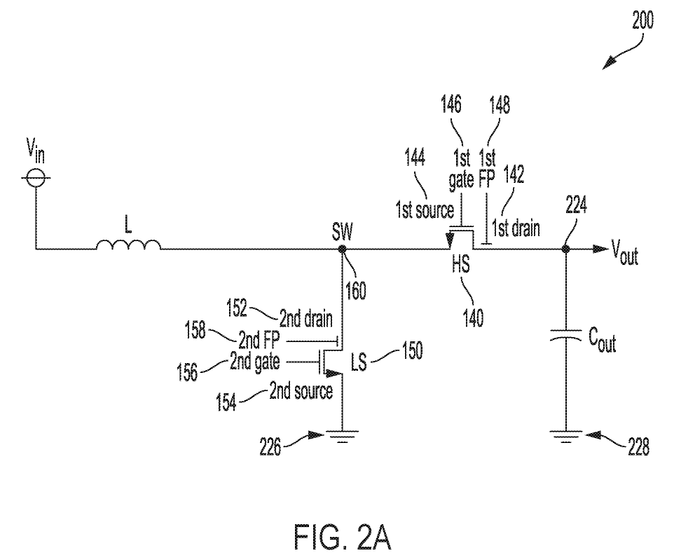

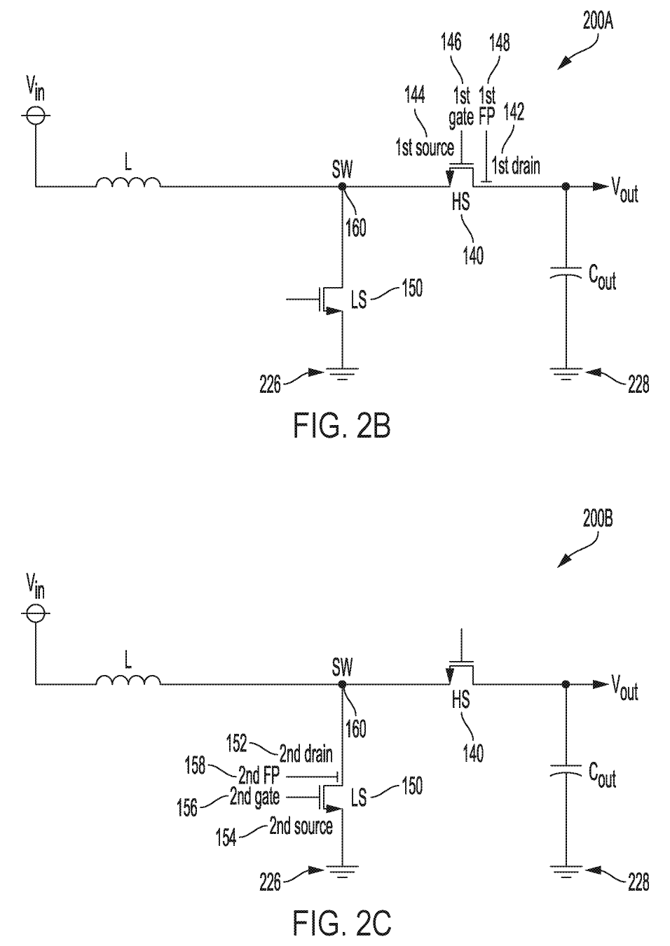

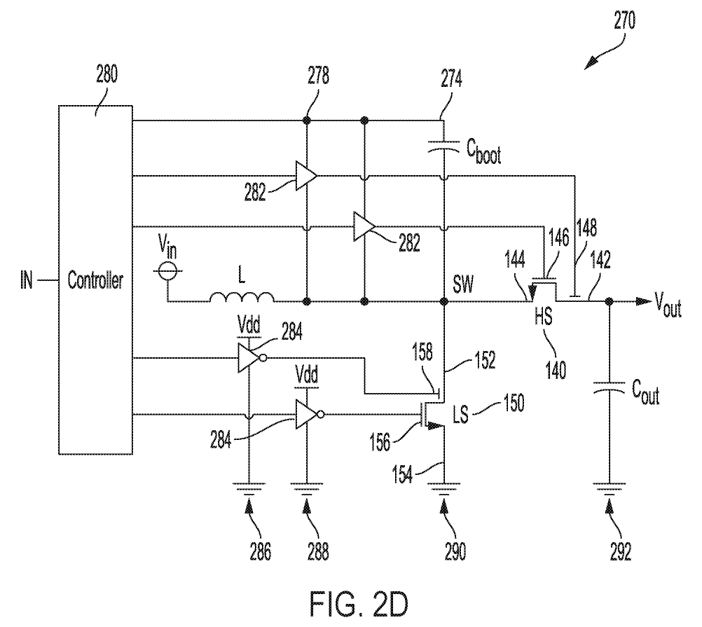

FIG. 2A illustrates a switching regulator 200 configured as a boost converter, according to an embodiment of the present disclosure. Elements having the same functions or structures as those previously described with reference to FIGS. 1A-1H are identified using the same reference numerals, and detailed descriptions of such components are omitted to avoid unnecessary repetition.

In this embodiment, the switching regulator 200 (boost converter) is configured to step up the input voltage Vᵢₙ to generate a higher output voltage Vₒᵤₜ. The inductor L and the high-side switch 140 are coupled in series between the input voltage Vᵢₙ and the output voltage Vₒᵤₜ via the common terminal 160 (switching node SW). The low-side switch 150 is coupled between the switching node SW and a ground potential 226. The output capacitor Cₒᵤₜ is connected between an output node 224 and a ground potential 228 to smooth the boosted output voltage Vₒᵤₜ.

The high-side switch 140 and low-side switch 150 are each implemented as MISFETs including independently controllable field-plate structures. In a preferred implementation, each MISFET is a laterally diffused MOSFET (LDMOSFET). Similar to FIGS. 1A-1H, the high-side switch 140 includes the first gate electrode 146, the first field-plate electrode 148, the first source 144, and the first drain 142. The low-side switch 150 includes the second gate electrode 156, the second field-plate electrode 158, the second source 154, and the second drain 152.

As depicted in FIGS. 1B-1E, the first gate electrode 146 and the first field-plate electrode 148 are spaced apart and configured to be controlled independently of each other. Likewise, the second gate electrode 156 and the second field-plate electrode 158 are spaced apart and independently driven. Independent biasing of the field-plate electrodes enables separate optimization of switching behavior and breakdown performance, thereby reducing losses during high-voltage switching transitions inherent in boost conversion.

During converter operation, the low-side switch 150 is periodically turned on to charge the inductor L from the input voltage Vᵢₙ, while the high-side switch 140 is periodically turned on to transfer stored energy from the inductor L to the output voltage Vₒᵤₜ through the switching node SW. The field-plate voltages may be set at higher potentials than their corresponding gate voltages to modulate the lateral electric field in each device’s drift region, improving breakdown-voltage capability and hot-carrier reliability while maintaining low specific on-resistance (Rsp) and converter efficiency.

FIG. 2B illustrates a switching regulator 200A in which only the high-side switch 140 includes a field-plate structure, according to an embodiment of the present disclosure. In this embodiment, the low-side switch 150 is implemented as a standard MOSFET without a field-plate electrode. This configuration may be useful where the high-side switch 140 experiences the largest voltage stress during the boost operation.

FIG. 2C illustrates a switching regulator 200B in which only the low-side switch 150 incorporates a field-plate structure, according to an embodiment of the present disclosure. This configuration may be useful when the low-side switch 150 conducts for longer intervals and thereby benefits more significantly from reduced conduction loss and improved hot-carrier-injection performance.

FIG. 2D illustrates a block diagram of a switching regulator 270 including a controller 280, high-side gate drivers 282, low-side gate drivers 284, and bootstrap circuit 274, according to an embodiment of the present disclosure. The controller 280 receives an input control signal IN and generates complementary control signals for the high-side switch 140 and low-side switch 150.

The high-side gate drivers 282 are configured to independently drive the first gate electrode 146 and the first field-plate electrode 148, while the low-side gate drivers 284 independently drive the second gate electrode 156 and the second field-plate electrode 158. Each of the low-side gate drivers 284 is supplied with a driver supply voltage (Vdd) that provides the necessary drive potential for controlling the low-side switch 150 and its associated field-plate electrode 158. The controller 280 operates the high-side and low-side switches 140, 150 in a complementary manner to prevent cross-conduction.

The bootstrap circuit 274 includes bootstrap capacitor C_{boot}, which is coupled between a supply node 278 of the high-side gate drivers 282 and the switching node SW. During operation, the bootstrap circuit 274 generates a boosted gate-drive voltage above the potential of the switching node SW to properly enhance the high-side switch 140 (for example, an N-channel high-side MISFET) even as its source voltage approaches the output voltage Vₒᵤₜ. This enables full turn-on and reduced conduction loss, improving boost-conversion efficiency.

The high-side gate drivers 282 and low-side gate drivers 284 may be referenced to different ground potentials, including ground potentials 286, 288, 290, and 292, depending on their respective circuit configurations and signal-level requirements. These separate ground references allow proper level shifting, noise isolation, and stable switching operation between the high-side and low-side control domains.

The switching regulators shown in FIGS. 2A-2D may be implemented as discrete circuits or monolithically integrated within a BCD semiconductor process. Although two switching devices are illustrated, the field-plate drive concepts described herein can be extended to other converter topologies including half-bridge, synchronous rectifier, and multi-level power stages.

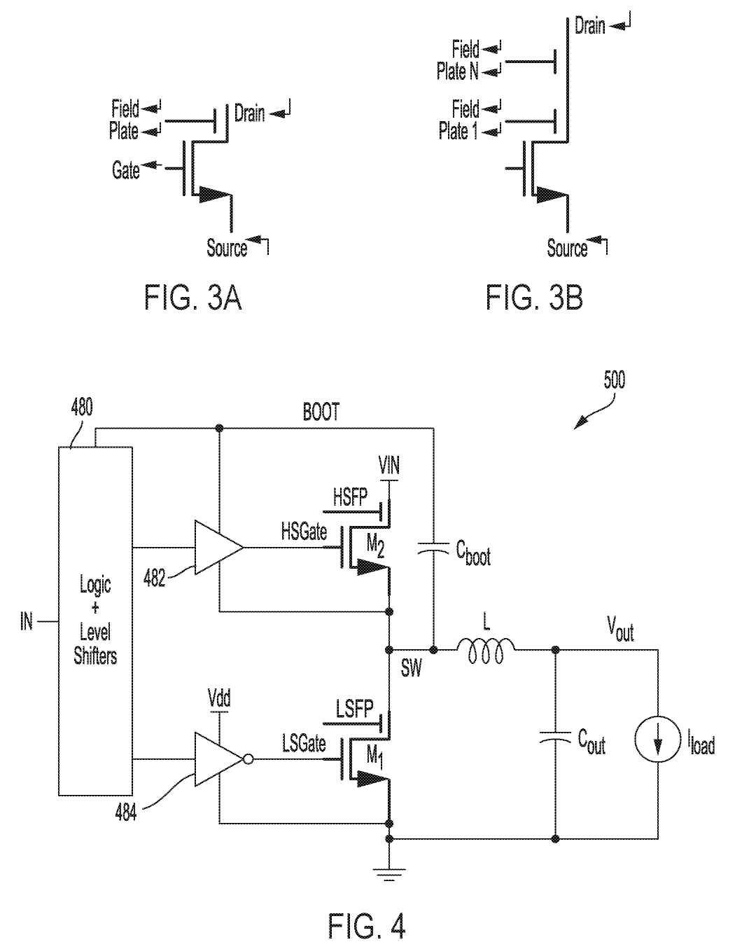

FIGS. 3A and 3B schematically illustrate symbolic representations of MISFET devices having a single field-plate electrode (FIG. 3A) or multiple field-plate electrodes (FIG. 3B) associated with a low-side switch configuration, according to an embodiment of the present disclosure. In both symbols, the field-plate electrode(s) extend laterally over a drift region and are electrically isolated from the channel-forming gate electrode, as described above.

FIG. 4 illustrates a switching regulator 500 configured as a buck converter, according to an embodiment of the present disclosure. The switching regulator 500 includes a logic and level-shifting circuit 480 configured to receive an input control signal (IN) and generate drive control signals for both the high-side and low-side switching devices. The high-side switch M₂ and low-side switch M₁ are each implemented as MISFETs. The high-side switch M₂ includes a high-side gate electrode (HSGate) and a high-side field-plate electrode (HSFP), while the low-side switch M₁ includes a low-side gate electrode (LSGate) and a low-side field-plate electrode (LSFP).

A high-side gate driver 482 is coupled between the logic and level-shifting circuit 480 and the HSGate of M₂, while a low-side gate driver 484 is coupled between the logic and level-shifting circuit 480 and the LSGate of M₁. The low-side gate driver 484 is supplied by a driver supply voltage (Vdd), which provides the necessary drive potential for the low-side transistor and its field-plate electrode.

A bootstrap capacitor (Cboot) is connected between a boosted-voltage node (BOOT) and the switching node (SW) to provide a boosted voltage for driving the high-side gate electrode HSGate at a potential greater than the input voltage (VIN). The inductor (L) is coupled between the switching node SW and the output node Vout, while an output capacitor (Cout) is coupled between the output node (Vout) and ground. A load current source (Iload) is connected in parallel with the output capacitor Cout to represent the load current drawn from the regulator output.

During operation, the low-side field-plate electrode (LSFP) may be biased at a fixed potential, dynamically modulated in response to the switching state, biased as a function of load current, left floating during selected intervals, or driven using any combination of these modes. Such dynamic field-plate control enhances breakdown-voltage capability, switching performance, and the trade-off among specific on-resistance (Rsp), breakdown voltage (BVDSS), and hot-carrier reliability during buck conversion operation.

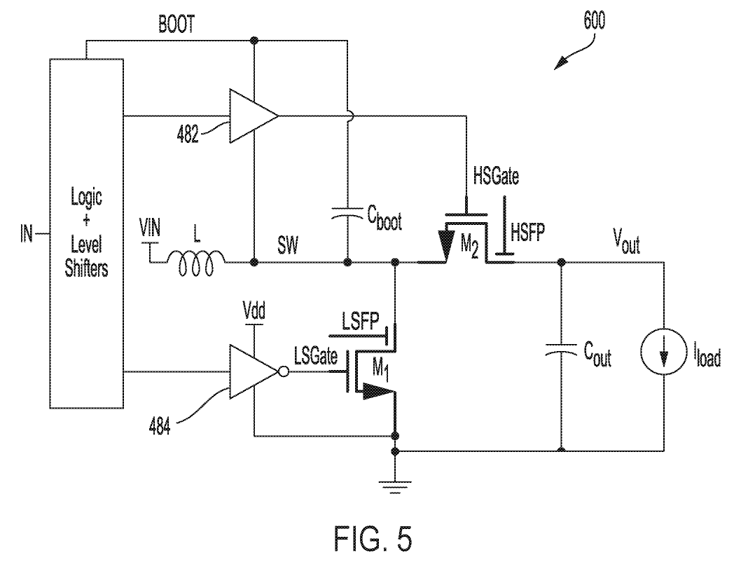

FIG. 5 illustrates a switching regulator 600, configured as a boost converter, having a configuration similar to that of the switching regulator 500 of FIG. 4, except that the arrangement of the high-side and low-side field-plate electrodes and their respective bias connections is modified. Elements identical or corresponding to those previously described with reference to FIG. 4 are denoted by the same reference numerals, and detailed descriptions are omitted for brevity.

In the configuration of FIG. 5, both the high-side transistor M₂ and the low-side transistor M₁ include respective field-plate electrodes (HSFP and LSFP) that are independently driven. The bootstrap capacitor Cboot is coupled between the boot node (BOOT) and the switching node SW, while the inductor L is connected between the input voltage (VIN) and SW, and the output capacitor Cout and load current source Iload are connected between the output node Vout and ground.

Unlike the configuration of FIG. 4, the high-side transistor M₂ in FIG. 5 is connected such that its source terminal is tied to the switching node SW and its drain is coupled to the output node Vout, thereby forming a boost-type topology rather than a buck-type topology. The low-side transistor M₁ is configured to provide current return to ground through its source terminal and is driven via the low-side gate driver 484 supplied by Vdd. Both the HSFP and LSFP electrodes may be dynamically biased, fixed at predetermined potentials, or left floating depending on the operating state of the converter, enabling adaptive field-plate control and improved switching performance relative to the configuration of FIG. 4.

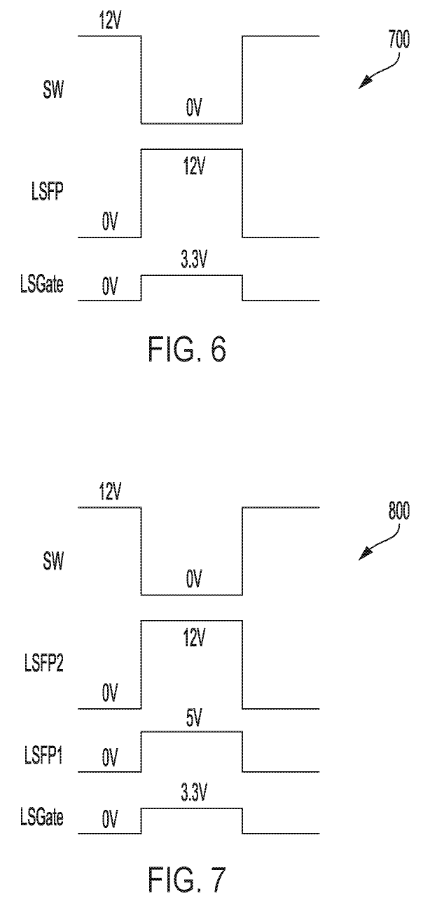

FIG. 6 shows example switching waveforms 700 for a buck converter low-side device including a single field-plate electrode LSFP, according to an embodiment of the present disclosure. The switching-node voltage SW transitions between approximately 0 V and 12 V. The LSFP electrode is biased to approximately 12 V during the ON state of the low-side switch, and transitions toward 0 V as the low-side switch turns OFF. The LSGate waveform follows a conventional gate-drive profile, for example approximately 0-3.3 V. This example illustrates a state-dependent field-plate drive technique in which the field-plate electrode supports conduction during the ON state and modulates the electric-field distribution during the OFF state.

FIG. 7 illustrates example timing waveforms 800 for a variation including two independently driven low-side field-plate electrodes LSFP₁ and LSFP₂, according to an embodiment of the present disclosure. As shown, LSFP₂ is driven to approximately 12 V during conduction, while LSFP₁ is driven to a different potential (e.g., approximately 5 V) and transitions in coordination with the gate-drive waveform to shape the potential gradient. Such staggered field-plate control enables adjustable electric-field slopes and optimized switching behavior over varying operating conditions.

The low-side field-plate control techniques described with reference to FIGS. 3-7 may likewise be applied to embodiments in which the high-side switch incorporates one or more field-plate electrodes, or where both high-side and low-side devices use field-plate structures. The appropriate selection of floating, fixed-potential, load-dependent, or state-dependent field-plate control may depend on detailed device structure and system-level requirements, supporting improved efficiency, robustness, and long-term reliability in buck, boost, and other converter topologies.

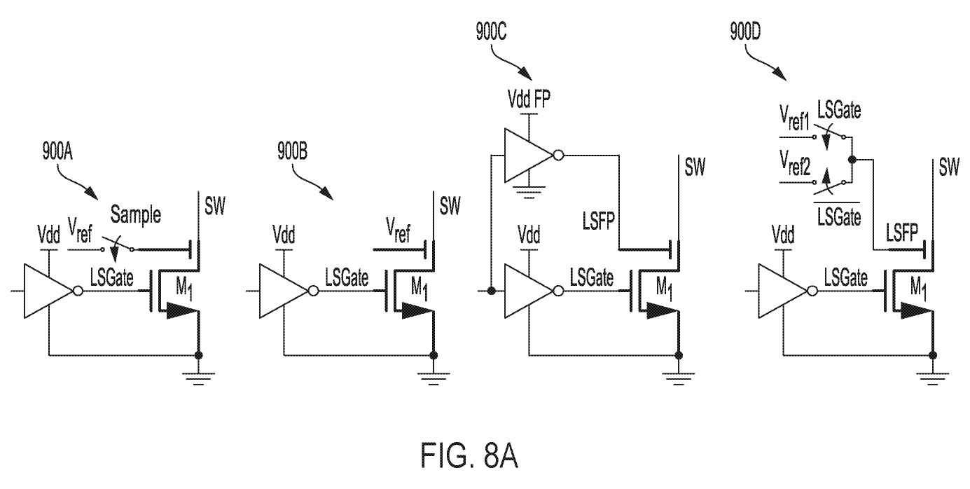

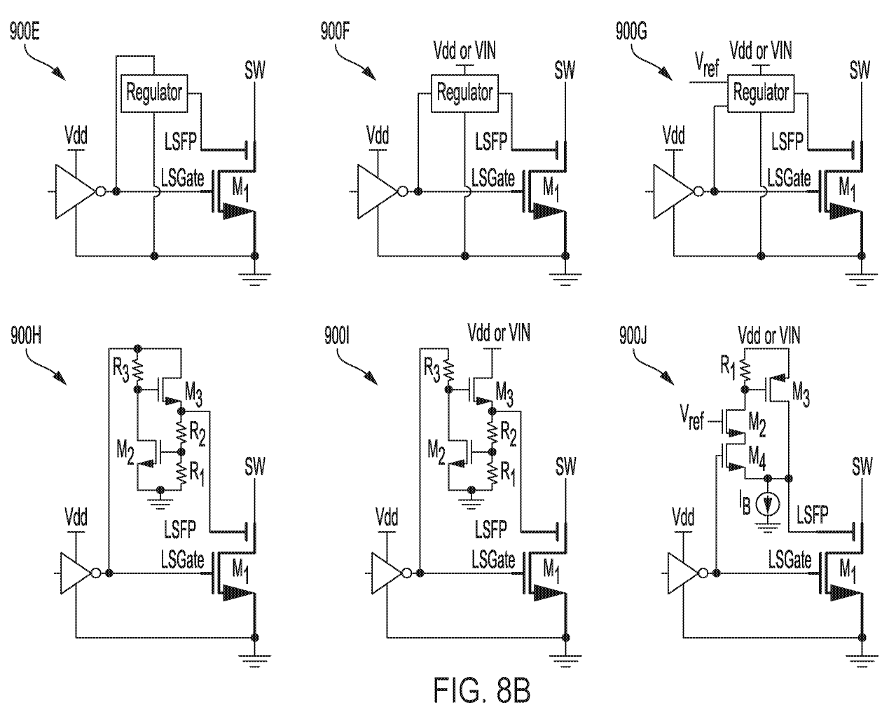

FIGS. 8A and 8B illustrate example configurations of low-side field-plate (LSFP) bias and driver circuits, according to various embodiments of the present disclosure. Elements having the same function or structure as those described above retain the same reference numerals, and detailed descriptions are omitted for clarity. Each configuration demonstrates an alternative scheme for establishing, modulating, or regulating the potential of the LSFP electrode to optimize electric-field distribution, switching loss, and device reliability.

In FIG. 8A, sub-circuits 900A through 900D represent examples of fundamental LSFP bias and reference schemes. Each sub-circuit includes a low-side transistor M₁ with the drain coupled to the switching node (SW) and source coupled to ground, with the gate driven by a low-side gate signal (LSGate) from a driver referenced to a supply voltage (Vdd). The low-side field-plate node is denoted LSFP. In the configuration of sub-circuit 900A, the LSFP node samples a reference voltage (Vref) through a sampling element (Sample). In one implementation, Sample can be synchronous with LSGate, so LSFP node samples Vref when M₁ is on. When M₁ is off, the Sample switch is disconnected from Vref and the LSFP node is floating. In the sub-circuit 900B, the LSFP is biased to a fixed reference voltage (Vref), while M₁ continues to be driven by LSGate from the Vdd-referenced driver, holding the field-plate potential constant with respect to ground throughout switching operation. In the sub-circuit 900C, the LSFP bias is supplied by a separate bias source (Vdd_FP) that is independent of the gate-drive supply (Vdd), with LSGate still driving the gate of M₁, allowing independent optimization of the gate and field-plate potentials for improved switching performance. In the sub-circuit 900D, the LSFP potential alternates between two selectable reference voltages (Vref₁ and Vref₂) according to the switching state, under control of a selector connected between Vref₁, Vref₂, and LSFP while M₁ is driven by LSGate, providing dynamic control between the on- and off-intervals of the low-side device.

FIG. 8B illustrates additional biasing and regulation examples shown as sub-circuits 900E through 900J. Each sub-circuit 900E through 900J includes a low-side transistor (M₁) with a drain coupled to the switching node (SW), a source connected to ground, and a gate driven by a gate signal (LSGate) from a driver referenced to a supply voltage (Vdd).

In the sub-circuit 900E, a voltage regulator (Regulator) is coupled between the gate signal (LSGate) and the low-side field-plate node (LSFP) to generate a controlled bias potential thereby stabilizing the field-plate voltage during load or line transients. In the sub-circuit 900F, the regulator receives its input from either Vdd or VIN, receives LSGate as an enable signal, and regulates the LSFP potential. The configuration of the sub-circuit 900G includes a regulator coupled to either Vdd or VIN that provides a feedback-controlled output to the LSFP node, thereby tightening the LSFP bias tolerance, maintaining isolation from the LSGate drive, and reducing transient deviations during switching operation.

In the sub-circuit 900H, one possible implementation of 900E uses a resistor-transistor network including transistors M₂ and M₃ and resistors R₁, R₂, and R₃. This network acts as a regulator that sets a field-plate potential (LSFP) to a value proportional to the gate to source voltage of M₂ in response to the gate-drive signal (LSGate). As a result, the LSFP voltage transitions smoothly during turn-on and turn-off of the low-side transistor M₁. In the sub-circuit 900I, one possible implementation of 900F uses a resistor-transistor network including transistors M₂ and M₃ and resistors R₁-R₃. This network acts as a regulator that sets LSFP to a value proportional to the gate to source voltage of M₂ in response to the gate-drive signal LSGate. In the sub-circuit 900J, one possible implementation of 900G uses a network including transistors M₂, M₃, and M₄, resistor R₁, and a current source Ib connected between VIN or Vdd and the LSFP node. This network acts as a regulator that sets LSFP to a value equal to Vref minus the gate to source voltage of M₂ in response to the gate-drive signal LSGate. Either Vref or Ib can be made proportional or indirectly proportional to the load current depending on the desired behavior. This arrangement allows the LSFP potential to vary as a function of load current while the main low-side device M₁ is driven by LSGate, thereby adaptively optimizing the low-side switching behavior.

Across these embodiments, the low-side field-plate (LSFP) may therefore be biased to a fixed voltage, dynamically modulated according to the switching state or load current, or regulated through a dedicated control network. The correct biasing approach may be selected according to the specific device structure, converter topology, and performance targets of the switching regulator.

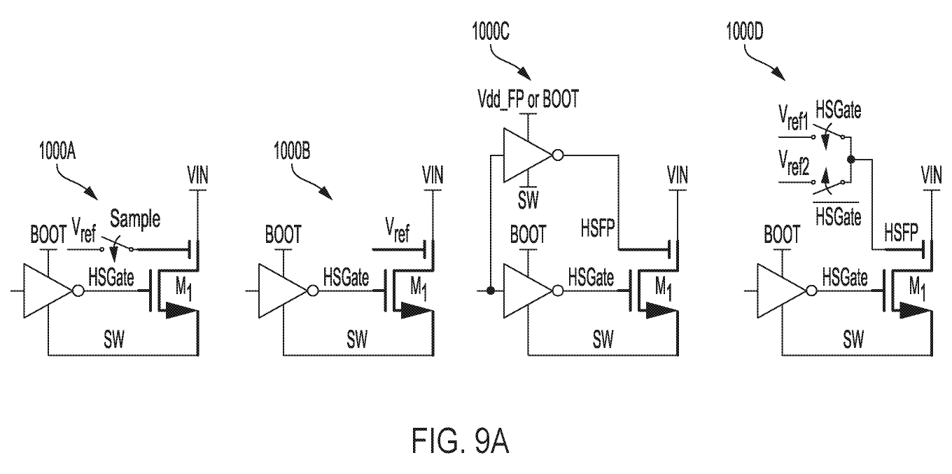

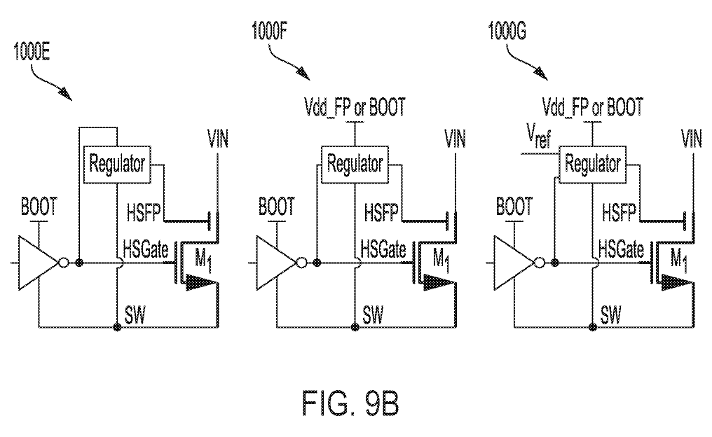

FIGS. 9A and 9B illustrate example configurations of high-side field-plate (HSFP) bias and driver circuits, according to various embodiments of the present disclosure. Elements having the same functions or structures as those previously described retain the same reference numerals, and detailed explanations thereof are omitted for conciseness. Each configuration provides an alternative technique for establishing or modulating the potential of the HSFP electrode relative to the switching node (SW), enabling optimization of high-side device performance across different operating conditions.

In FIG. 9A, sub-circuits 1000A through 1000D represent examples of fundamental HSFP bias and reference schemes. In the configuration of sub-circuit 1000A, the HSFP node samples a reference voltage (Vref) through a sampling path. In the sub-circuit 1000B, the HSFP is biased to a fixed reference voltage (Vref) relative to the switch node (SW), maintaining a constant field-plate potential independent of the instantaneous switching-node voltage. In the sub-circuit 1000C, the HSFP is supplied by an auxiliary bias (Vdd_FP or BOOT) that is distinct from the gate-drive supply, allowing independent control of the gate and field-plate potentials for improved breakdown and switching performance. In the sub-circuit 1000D, the HSFP bias alternates between two selectable reference voltages (Vref₁ and Vref₂) depending on the switching state, thereby providing dynamic modulation between on-state and off-state operation of the high-side transistor M₁.

FIG. 9B illustrates additional embodiments employing regulated bias schemes for the high-side field-plate (HSFP) electrode. In the sub-circuit 1000E, a voltage regulator (Regulator) is coupled between the gate signal (HSGate) and the high-side field-plate node (HSFP) to generate a controlled bias potential relative to the switching node (SW), thereby maintaining a stable field-plate bias during switching transients. In the sub-circuit 1000F, the regulator receives its input from either Vdd_FP or BOOT, receives HSGate as an enable signal, and regulates the HSFP potential relative to SW node, thereby tailoring the electric-field distribution within the drift region of the high-side device. The configuration of the sub-circuit 1000G includes a regulator coupled to either Vdd_FP or BOOT that provides a feedback-controlled output to the HSFP node for tighter regulation and improved noise immunity.

Across the embodiments shown in FIGS. 9A and 9B, the high-side field-plate (HSFP) may be floating, biased to a fixed potential, regulated relative to VIN, BOOT or SW, or dynamically modulated between multiple bias levels depending on converter state. These examples collectively illustrate various implementations of HSFP drive and bias circuitry that may be selected according to the desired trade-off between breakdown-voltage capability, switching loss, and efficiency in high-side operation.

In various embodiments, the switching regulators described herein may utilize N-channel MOSFET devices for both high-side and low-side switches. Each field plate electrode may receive a supplied voltage that is different from a supplied voltage of its corresponding gate electrode to independently control the electric-field profile during operation. In some implementations, a supplied voltage of a field plate electrode may be greater than the supplied voltage of the gate electrode to generate a predetermined electric potential favorable for modulating the electric field in the drift region. During operation of a switching regulator, a boost voltage may be generated, for example by a bootstrap circuit, to raise the potential of the high-side gate with respect to a switching voltage present at the common terminal (switching node). In certain embodiments, a field plate electrode may be divided into a plurality of electrically isolated field plates that are controlled at different bias levels or activation timings. These configurations provide enhanced support for efficient and reliable switching operations in the disclosed semiconductor devices.

### Examples

Example 1. A switching regulator comprising:
a high-side switch and a low-side switch coupled in series between an input voltage and a ground potential via a common terminal;
an inductor coupled to the common terminal; and
an output capacitor configured to generate an output voltage based on a current flowing through the inductor, wherein
the high-side switch is a first MISFET with a first field plate structure including a first gate electrode and a first field plate electrode,
the first gate electrode and the first field plate electrode are configured to be controlled independently of each other,
the low-side switch is a second MISFET with a second field plate structure including a second gate electrode and a second field plate electrode,
the second gate electrode and the second field plate electrode are configured to be controlled independently of each other.

Example 2. The switching regulator according to Example 1, wherein

the first gate electrode and the first field plate electrode are spaced apart from each other, and

the second gate electrode and the second field plate electrode are spaced apart from each other.

Example 3. The switching regulator according to any one of Examples 1 or 2, wherein

the first MISFET and the second MISFET are LDMOSFETs (Laterally Diffused Metal-Oxide-Semiconductor Field Effect Transistors).

Example 4. The switching regulator according to any one of Examples 1 to 3, wherein

the first gate electrode and the first field plate electrode are each supplied with a different voltage, and

the second gate electrode and the second field plate electrode are each supplied with a different voltage.

Example 5. The switching regulator according to Example 4, wherein

a supplied voltage of the first field plate electrode is higher than a supplied voltage of the first gate electrode, and

a supplied voltage of the second field plate electrode is higher than a supplied voltage of the second gate electrode.

Example 6. The switching regulator according to any one of Examples 1 to 4, wherein

the first gate electrode and the first field plate electrode are simultaneously activated, and

the second gate electrode and the second field plate electrode are simultaneously activated.

Example 7. The switching regulator according to Example 1, wherein

the first field plate electrode is divided into a plurality of first field plates, and

the second field plate electrode is divided into a plurality of second field plates.

Example 8. The switching regulator according to Example 7, wherein

the first gate electrode and the plurality of first field plates are each supplied with a different voltage respectively,

the second gate electrode and the plurality of second field plates are each supplied with a different voltage respectively,

the plurality of first field plates is simultaneously activated, and

the plurality of second field plates is simultaneously activated.

Example 9. The switching regulator according to any one of Examples 1 to 8, further comprising:
gate drivers configured to drive the first and second gate electrodes and the first and second field plate electrodes respectively; and
a controller configured to control the gate drivers, wherein
each of the first and second gate electrodes and the first and second field plate electrodes are controlled independently by the controller via each gate driver, and
a group of the first gate electrode and the first field plate electrode and a group of the second gate electrode and the second field plate electrode are controlled in a complementary manner by the controller.

Example 10. The switching regulator according to Example 9, further comprising: a bootstrap circuit including a bootstrap capacitor coupled between a gate driver of the first gate electrode and the common terminal, wherein the first MISFET is N-channel MOSFET, and the bootstrap circuit is configured to generate a boost voltage enhanced by a predetermined electric potential above a switching voltage at the common terminal.

Example 11. A switching regulator comprising:
an inductor and a high-side switch coupled in series between an input voltage and an output voltage via a common terminal;
a low-side switch coupled between the common terminal and a ground potential; and
an output capacitor configured to generate the output voltage based on a current flowing through the inductor, wherein
the high-side switch is a first MISFET with a first field plate structure including a first gate electrode and a first field plate electrode,
the first gate electrode and the first field plate electrode are configured to be controlled independently of each other,
the low-side switch is a second MISFET with a second field plate structure including a second gate electrode and a second field plate electrode,
the second gate electrode and the second field plate electrode are configured to be controlled independently of each other.

Example 12. The switching regulator according to Example 11, wherein

the first gate electrode and the first field plate electrode are spaced apart from each other, and

the second gate electrode and the second field plate electrode are spaced apart from each other.

Example 13. The switching regulator according to any one of Examples 11 or 12, wherein

the first MISFET and the second MISFET are LDMOSFETs (Laterally Diffused Metal-Oxide-Semiconductor Field Effect Transistors).

Example 14. The switching regulator according to any one of Examples 11 to 13, wherein

the first gate electrode and the first field plate electrode are each supplied with a different voltage, and

the second gate electrode and the second field plate electrode are each supplied with a different voltage.

Example 15. The switching regulator according to Example 14, wherein

a supplied voltage of the first field plate electrode is higher than a supplied voltage of the first gate electrode, and

a supplied voltage of the second field plate electrode is higher than a supplied voltage of the second gate electrode.

Example 16. The switching regulator according to any one of Examples 11 to 14, wherein

the first gate electrode and the first field plate electrode are simultaneously activated, and

the second gate electrode and the second field plate electrode are simultaneously activated.

Example 17. The switching regulator according to any one of Examples 11 to 16, wherein

the first field plate electrode is divided into a plurality of first field plates, and

the second field plate electrode is divided into a plurality of second field plates.

Example 18. The switching regulator according to Example 17, wherein

the first gate electrode and the plurality of first field plates are each supplied with a different voltage,

the second gate electrode and the plurality of second field plates are each supplied with a different voltage,

the plurality of first field plates is simultaneously activated, and

the plurality of second field plates is simultaneously activated.

Example 19. The switching regulator according to any one of Examples 11 to 18, further comprising:
gate drivers configured to drive the first and second gate electrodes and the first and second field plate electrodes respectively; and
a controller configured to control the gate drivers, wherein
each of the first and second gate electrodes and the first and second field plate electrodes are controlled independently by the controller via each gate driver, and
a group of the first gate electrode and the first field plate electrode and a group of the second gate electrode and the second field plate electrode are controlled in a complementary manner by the controller.

Example 20. The switching regulator according to Example 19, further comprising:
a bootstrap circuit including a bootstrap capacitor coupled between a gate driver of the first gate electrode and the common terminal, wherein
the first MISFET is N-channel MOSFET, and
the bootstrap circuit is configured to generate a boost voltage enhanced by a predetermined electric potential above a switching voltage at the common terminal.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Spatially relative terms, such as “inner,” “outer,” “beneath,” “below,” “lower,” “above,” “upper,” “top,” “bottom,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

Approximating language, as used herein throughout the specification and claims, may be applied to modify any quantitative representation that could permissibly vary without resulting in a change in the basic function to which it is related. Accordingly, a value modified by a term or terms, such as “about”, “approximately” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A switching regulator comprising:
a high-side switch and a low-side switch coupled in series between an input voltage and a ground potential via a common terminal;
an inductor coupled to the common terminal; and
an output capacitor configured to generate an output voltage based on a current flowing through the inductor, wherein
the high-side switch is a first MISFET with a first field plate structure including a first gate electrode and a first field plate electrode,
the first gate electrode and the first field plate electrode are configured to be controlled independently of each other,
the low-side switch is a second MISFET with a second field plate structure including a second gate electrode and a second field plate electrode,
the second gate electrode and the second field plate electrode are configured to be controlled independently of each other.

2. The switching regulator according to claim 1, wherein
the first gate electrode and the first field plate electrode are spaced apart from each other, and
the second gate electrode and the second field plate electrode are spaced apart from each other.

3. The switching regulator according to claim 1, wherein
the first MISFET and the second MISFET are LDMOSFETs (Laterally Diffused Metal-Oxide-Semiconductor Field Effect Transistors).

4. The switching regulator according to claim 1, wherein
the first gate electrode and the first field plate electrode are each supplied with a different voltage, and
the second gate electrode and the second field plate electrode are each supplied with a different voltage.

5. The switching regulator according to claim 4, wherein
a supplied voltage of the first field plate electrode is higher than a supplied voltage of the first gate electrode, and
a supplied voltage of the second field plate electrode is higher than a supplied voltage of the second gate electrode.

6. The switching regulator according to claim 1, wherein
the first gate electrode and the first field plate electrode are simultaneously activated, and
the second gate electrode and the second field plate electrode are simultaneously activated.

7. The switching regulator according to claim 1, wherein
the first field plate electrode is divided into a plurality of first field plates, and
the second field plate electrode is divided into a plurality of second field plates.

8. The switching regulator according to claim 7, wherein
the first gate electrode and the plurality of first field plates are each supplied with a different voltage respectively,
the second gate electrode and the plurality of second field plates are each supplied with a different voltage respectively,
the plurality of first field plates is simultaneously activated, and
the plurality of second field plates is simultaneously activated.

9. The switching regulator according to claim 1, further comprising:
gate drivers configured to drive the first and second gate electrodes and the first and second field plate electrodes respectively; and
a controller configured to control the gate drivers, wherein
each of the first and second gate electrodes and the first and second field plate electrodes are controlled independently by the controller via each gate driver, and
a group of the first gate electrode and the first field plate electrode and a group of the second gate electrode and the second field plate electrode are controlled in a complementary manner by the controller.

10. The switching regulator according to claim 9, further comprising:
a bootstrap circuit including a bootstrap capacitor coupled between a gate driver of the first gate electrode and the common terminal, wherein
the first MISFET is N-channel MOSFET, and
the bootstrap circuit is configured to generate a boost voltage enhanced by a predetermined electric potential above a switching voltage at the common terminal.

11. A switching regulator comprising:
an inductor and a high-side switch coupled in series between an input voltage and an output voltage via a common terminal;
a low-side switch coupled between the common terminal and a ground potential; and
an output capacitor configured to generate the output voltage based on a current flowing through the inductor, wherein
the high-side switch is a first MISFET with a first field plate structure including a first gate electrode and a first field plate electrode,
the first gate electrode and the first field plate electrode are configured to be controlled independently of each other,
the low-side switch is a second MISFET with a second field plate structure including a second gate electrode and a second field plate electrode,
the second gate electrode and the second field plate electrode are configured to be controlled independently of each other.

12. The switching regulator according to claim 11, wherein
the first gate electrode and the first field plate electrode are spaced apart from each other, and
the second gate electrode and the second field plate electrode are spaced apart from each other.

13. The switching regulator according to claim 11, wherein
the first MISFET and the second MISFET are LDMOSFETs (Laterally Diffused Metal-Oxide-Semiconductor Field Effect Transistors).

14. The switching regulator according to claim 11, wherein
the first gate electrode and the first field plate electrode are each supplied with a different voltage, and
the second gate electrode and the second field plate electrode are each supplied with a different voltage.

15. The switching regulator according to claim 14, wherein
a supplied voltage of the first field plate electrode is higher than a supplied voltage of the first gate electrode, and
a supplied voltage of the second field plate electrode is higher than a supplied voltage of the second gate electrode.

16. The switching regulator according to claim 11, wherein
the first gate electrode and the first field plate electrode are simultaneously activated, and
the second gate electrode and the second field plate electrode are simultaneously activated.

17. The switching regulator according to claim 11, wherein
the first field plate electrode is divided into a plurality of first field plates, and
the second field plate electrode is divided into a plurality of second field plates.

18. The switching regulator according to claim 17, wherein
the first gate electrode and the plurality of first field plates are each supplied with a different voltage,
the second gate electrode and the plurality of second field plates are each supplied with a different voltage,
the plurality of first field plates is simultaneously activated, and
the plurality of second field plates is simultaneously activated.

19. The switching regulator according to claim 11, further comprising:
gate drivers configured to drive the first and second gate electrodes and the first and second field plate electrodes respectively; and
a controller configured to control the gate drivers, wherein
each of the first and second gate electrodes and the first and second field plate electrodes are controlled independently by the controller via each gate driver, and
a group of the first gate electrode and the first field plate electrode and a group of the second gate electrode and the second field plate electrode are controlled in a complementary manner by the controller.

20. The switching regulator according to claim 19, further comprising:
a bootstrap circuit including a bootstrap capacitor coupled between a gate driver of the first gate electrode and the common terminal, wherein
the first MISFET is N-channel MOSFET, and
the bootstrap circuit is configured to generate a boost voltage enhanced by a predetermined electric potential above a switching voltage at the common terminal.
